(19) United States
(12) Patent Application Publication
(10) Pub. No.: US 2011/0031301 A1
(43) Pub. Date: Feb. 10, 2011

(54) Joining of Electrical Generator Components

(76) Inventors: David S. Segletes, York, SC (US); William F. Jones, York, SC (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/536,893

(22) Filed: Aug. 6, 2009

(51) Int. Cl. B23K 31/02

(52) U.S. Cl. 228/198

(57) ABSTRACT

A method for joining components to be used in an electrical generator. First and second components are provided. The first and second components are preheated and a reactive bonding material is disposed between and in contact with the first and second components. The reactive bonding material includes a first material, which is a brazing material, and a second material that is capable of melting the first material upon an initiation of an exothermic reaction in the second material. An exothermic reaction is initiated in the second material to effect a release of thermal energy from the second material to melt the first material. Upon a cooling and solidification of the first material, the first material creates a bond between a first surface of the first component and a second surface of the second component to join the first and second components together.

### FIELD OF THE INVENTION

The present invention relates to joining components in an electrical generator, and, more particularly, to joining electrical generator conductors using a foil including a high energy material and a reactive bonding material.

### BACKGROUND OF THE INVENTION

Electrical generator windings, in addition to other generator components that are at least partially formed from copper or copper alloys, collectively referred to as “conductors” of the generator, are typically brazed together, such as by using an inductive heat brazing process, a flame brazing process, or an electrical resistance brazing process. These brazing processes are used to melt a brazing material that is disposed within an area to be brazed, such as a joint between two components to be joined together. These joints between the components are often located in areas where access thereto is limited. Thus, to provide the thermal energy required to melt the brazing material, the entire area proximate to the joint must be heated to temperatures high enough to melt the brazing material. This heating of large volumes of the generator components to temperatures sufficient to melt the brazing material may have undesirable effects, such as an alteration of mechanical and/or electrical properties of the components. Further, induction heat brazing, flame brazing, and electrical resistance brazing are relatively slow processes, as the time required to melt the brazing material can take up to about five minutes, and the time required for the components to cool takes additional time.

### SUMMARY OF THE INVENTION

In accordance with a first aspect of the present invention, a method is provided for joining components to be used in an electrical generator. A first component having a first surface is provided and a second component having a second surface is provided. A reactive bonding material is disposed between and in contact with the first surface and the second surface. The reactive bonding material includes a first material, which comprises a brazing material, and a second material that is capable of melting the first material upon an initiation of an exothermic reaction in the second material. At least one of the first surface and the second surface is heated to a temperature lower than a melting temperature of the first material of the reactive bonding material. An exothermic reaction is initiated in the second material to effect a release of thermal energy from the second material to the first material to melt the first material. Upon a cooling and solidification of the first material, the first material creates a bond between the first surface and the second surface to join the first component to the second component.

In accordance with a second aspect of the present invention, a method is provided for joining and forming an electrical connection between electrically conductive components to be used in an electrical generator. A first electrically conductive component having a first surface is provided, and a second electrically conductive component having a second surface is provided. A reactive bonding material is disposed between and in contact with the first surface and the second surface. The reactive bonding material includes a first material that comprises a brazing material and a second material capable of melting the first material upon an initiation of an exothermic reaction in the second material. An exothermic reaction is initiated in the second material to effect a release of thermal energy from the second material to the first material to melt the first material. Upon a cooling and solidification of the first material, the first material creates an electrically conductive bond between the first surface and the second surface to join the first component to the second component.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a perspective view illustrating exemplary locations in an electrical generator where joints are made between adjacent components in accordance with embodiments of the invention;

FIG. 2 is an exploded view of two components to be joined together in accordance with an embodiment of the invention;

FIG. 2A is an enlarged cross sectional view taken along line 2A-2A in FIG. 2;

FIG. 3 is an enlarged view of a joint between two components that have been joined together in accordance with an embodiment of the present invention; and

FIG. 4 illustrates steps used to join together generator components according to an embodiment of the invention.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

The present invention provides for a method for joining together components used in an electrical generator, such as, for example, generator components formed from copper or a copper alloy, hereinafter collectively referred to as “conductors”. The method is implemented using a reactive bonding material that includes a brazing material and an exothermically reactive material that is used to melt the brazing material upon an initiation of an exothermic reaction in the exothermically reactive material. Upon a cooling and solidification of the brazing material, the reactive bonding material structurally joins the conductors together and provides an electrically conductive bond between the joined conductors.

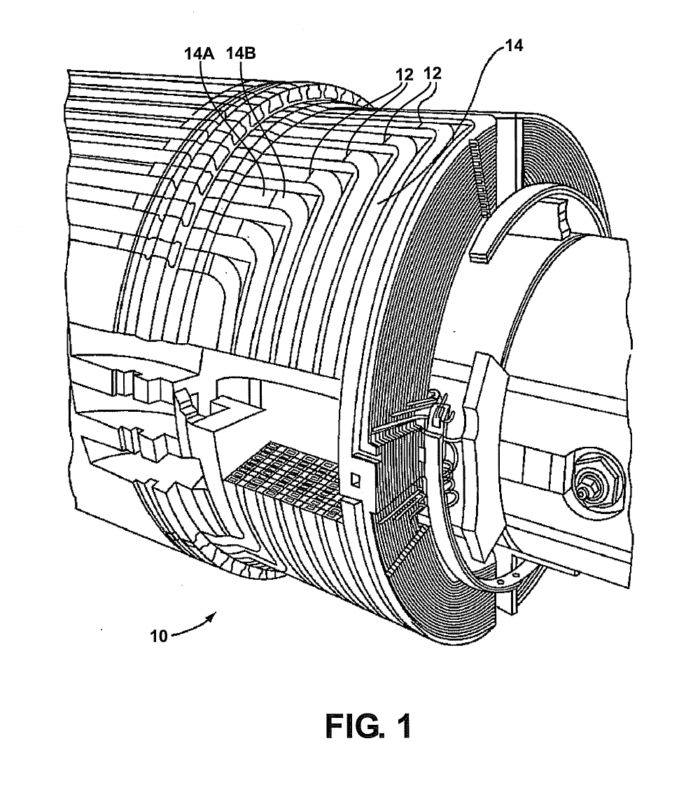

Referring to FIG. 1, an electrical generator 10 is illustrated that includes components, i.e., conductors, which are joined, i.e., brazed, together according to embodiments of the invention. The generator 10 illustrated in FIG. 1 includes a plurality of exemplary locations where braze joints 12 according to embodiments of the invention have been formed between adjacent conductors. In the embodiment shown in FIG. 1, braze joints 12 are located between copper coil ends or windings 14. Other suitable conductors to be joined together according to embodiments of the invention include, for example, end turns, consolidation joints, and series connections between top and bottom strands. It is understood that braze joints 12 may be formed in any or all of the exemplary locations illustrated in FIG. 1, as well as between the exemplary conductors noted above.

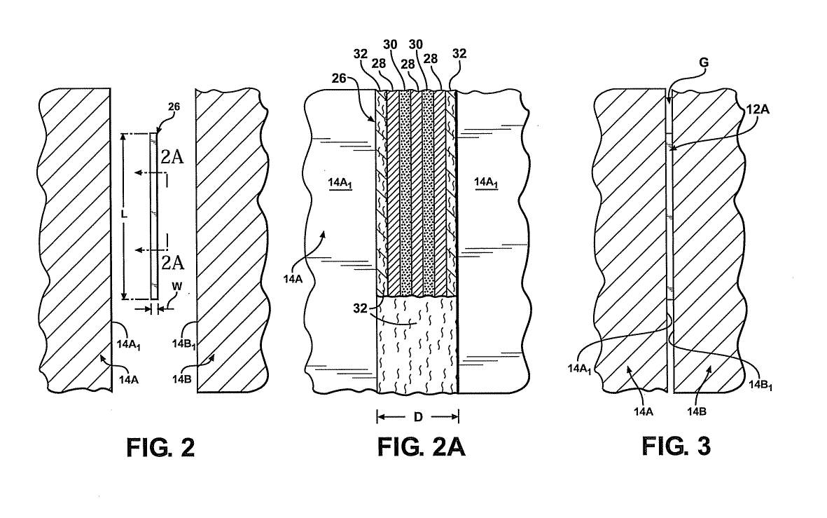

Referring to FIG. 2, an exploded view illustrates first and second conductors 14A, 14B to be joined together using a brazing procedure according to embodiments of the invention. In the embodiment shown, the first and second conductors 14A, 14B comprise first and second windings, although it is understood that other generator conductors, such as those listed above, may be joined using the structure and methods described herein. The first conductor 14A includes a first surface 14A₁ and the second conductor 14B includes a second surface 14B₁ to be joined to the first surface 14A₁ of the first conductor 14A.

A reactive bonding material 26 is used to form a braze joint 12A (see FIG. 3) between the first and second conductors 14A, 14B. Referring to FIG. 2A, the reactive bonding material 26 includes a brazing material 28 and an exothermically reactive material 30. In the embodiment shown, the reactive bonding material 26 comprises plural alternating layers of the brazing material 28 and the exothermically reactive material 30. It is noted that the layers illustrated in FIG. 2A have been enlarged for clarity and could be much smaller than shown. It is also noted that additional or fewer alternating layers of the brazing material 28 and the exothermically reactive material 30 may be used to form the reactive bonding material 26. Further, the layers of the brazing material 28 and the exothermically reactive material 30 may be oriented differently than the top to bottom orientation illustrated in FIG. 2A, e.g., the layers may extend from left to right, or other suitable orientations.

The brazing material 28 may comprise, for example, a combination of silver, copper, and phosphorus, cadmium, nickel, tin or zinc. For example, the brazing material 28 may comprise about 1 wt % to about 60 wt % silver, about 30 wt % to about 80 wt. % copper, and at least one of about 4 wt % to about 9 wt % phosphorus, about 10 wt % to about 25 wt % cadmium, about 1 wt % to about 5 wt % nickel, about 1 wt % to about 10 wt % tin, and about 5 wt % to about 40 wt % zinc. In a preferred embodiment, the brazing material 28 is American Welding Society A 5.8 BCuP-5. The exothermically reactive material 30 may comprise a high energy explosive material, such as, for example, an exothermic powder layer. One suitable type of reactive bonding material 26 is a NANOFOIL (NANOFOIL is a registered trademark of Reactive NanoTechnologies, Inc.), manufactured by Reactive NanoTechnologies, Inc., which may come pre-assembled with the alternating layers of the brazing material 28 and the exothermically reactive material 30, although other suitable types of reactive bonding materials 26 may be used. The NANOFOIL may comprise, for example, reactive multilayer sheets that alternate between two materials, each comprising one of the following exemplary element pairs: nickel and aluminum, aluminum and zirconium, aluminum and palladium, titanium and silicon, zirconium and silicon, niobium and silicon, titanium and carbon, zirconium and carbon, hafnium and carbon, titanium and boron, zirconium and boron, hafnium and boron, aluminum and copper oxide, aluminum and iron oxide.

The reactive bonding material 26 may optionally include a fluxing agent 32 that is employed to clean the first and second surfaces 14A₁, 14B₁. The fluxing agent 32 may comprise, for example, a layer including phosphorus that forms outer surfaces of the reactive bonding material 26 as shown in FIG. 2A, or the fluxing agent 32 may comprise a material formed at least partially from boron or fluorine. One suitable type of fluxing agent 32 is disclosed in U.S. Pat. No. 6,277,210, the entire disclosure of which is hereby incorporated by reference herein. As will be described herein, the fluxing agent 32 cleans the first and second surfaces 14A₁, 14B₁ and prepares the first and second surfaces 14A₁, 14B₁ to be brazed together. The fluxing agent 32 may be incorporated into the reactive bonding material 26, as shown in FIG. 2A, or may be applied to the first and second surfaces 14A₁, 14B₁ before the reactive bonding material 26 is disposed between the first and second surfaces 14A₁, 14B₁.

Once the reactive bonding material 26 is disposed between the first and second surfaces 14A₁, 14B₁, the reactive bonding material 26 is treated in a manner that will be described in detail herein. Once treated, the reactive bonding material 26 forms the braze joint 12A (see FIG. 3) between the first and second windings 14A, 14B. The braze joint 12A creates a secure structural bond between the first and second conductors 14A, 14B. Further, the braze joint 12A may provide only a small amount of electrical resistance such that the braze joint 12A provides high electrical conductance between the first and second conductors 14A, 14B.

An exemplary length L (see FIG. 2) of the braze joint 12A illustrated in FIG. 3 may be in a range of from about 3.2 cm to about 4.0 cm, an exemplary width W (see FIG. 2) of the braze joint 12A, i.e., defined by a gap G (see FIG. 3) between the joined first and second conductors 14A, 14B, may be in a range of from about 0.254 mm to about 2.0 mm, and an exemplary depth D (see FIG. 2A) of the braze joint 12A may be about 6 mm.

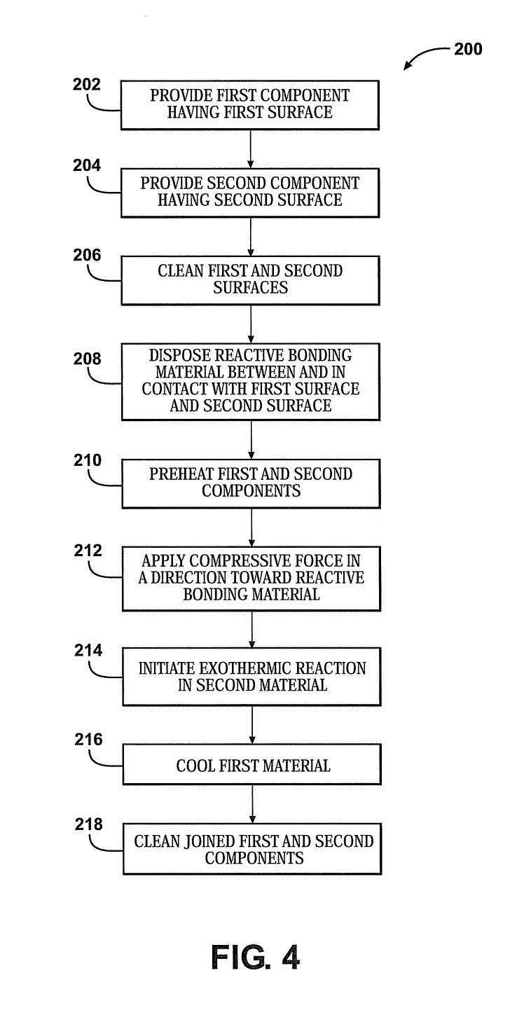

Referring to FIG. 4, a method for joining components, i.e., conductors, for use in an electrical generator, such as the electrical generator 10 illustrated in FIG. 1, is illustrated. At 202, a first component is provided. The first component comprises a first surface to be joined to a second surface of a second component. The first component may be, for example, a coil end or winding, an end turn, a consolidation joint, a series connection between top and bottom strand, etc., and may be formed at least partially from copper, i.e., copper or a copper alloy.

A second component is provided at 204. The second component comprises a second surface to be joined to the first surface of the first component. The second component may be, for example, a coil end or winding, an end turn, a consolidation joint, a series connection between top and bottom strand, etc., and may be formed at least partially from copper, i.e., copper or a copper alloy.

The first and second surfaces are cleaned at 206. The cleaning of the first and second surfaces may be accomplished by applying a fluxing agent to the first and second surfaces. As noted above, the fluxing agent may applied to clean the first and second surfaces before a reactive bonding material is disposed between the first and second surfaces, or the fluxing agent may be incorporated into the reactive bonding material. Additionally, the cleaning of the first and second surfaces may be accomplished by applying a solvent, such as, for example, a denatured alcohol to the first and second surfaces before the reactive bonding material is disposed therebetween.

At 208, the reactive bonding material is disposed between and in contact with the first surface of the first component and the second surface of the second component. The reactive bonding material, which is described above in greater detail, includes a first material comprising a brazing material and a second material comprising an exothermically reactive material that, upon an initiation and execution of an exothermic reaction in the second material, gives off enough thermal energy to melt the first material. As noted above, the reactive bonding material may also include a fluxing agent to clean the first and second surfaces and prepare the first and second surfaces to be brazed.

The first and second components are preheated at 210 to a temperature lower than the melting temperature of the first material, and preferably up to a temperature in a range from about 100° Celsius (C) to about 400° C. It is noted that the preheating of the first and second components may be performed before or after the reactive bonding material is disposed between the first and second surfaces. That is, the first and second components may be preheated without the reactive bonding material. The first and second components, e.g., at least the first and second surfaces thereof, respectively, may be preheated using any suitable method, such as, for example, using an induction heating process, wherein a high frequency alternating current is provided to the components, using a flame process, e.g., with a torch, or using an electrical resistance process, wherein a heat producing internal resistance is generated in the components, e.g., by passing 1000 amps through the components. It is noted that the first and second components are preferably preheated to a temperature that is sufficiently low enough so as to avoid adversely affecting the surrounding materials and the structure being preheated.

Once the first and second components are preheated and the reactive bonding material is disposed therebetween, a compressive force is applied to one or both of the first and second components in a direction toward the reactive bonding material at 212. This may be accomplished, for example, by positioning the first component such that the first surface thereof faces in an upward direction. The reactive bonding material may be positioned on top of the first surface, and the second surface of the second component may be placed in a downward direction on top of the reactive bonding material. The compressive force exerted on the reactive bonding material would thus be provided by the weight of the second component pushing downward on the reactive bonding material, and thus applying a compressive force on the reactive bonding material between the first and second components. It is noted that other methods of applying a compressive force on the reactive bonding material can be used without departing from the spirit and scope of the invention.

An exothermic reaction is initiated in the second material at 214. The exothermic reaction may be initiated in the second material, for example, by applying an electrical impulse to the second material, such as with a battery and associated electrical leads. The electrical impulse initiates the exothermic reaction in the second material to effect a release of thermal energy from the second material. A first portion of the thermal energy is absorbed by the first and second components, and a second portion of the thermal energy is used to heat the first material to melt the first material, e.g., heats the first material up to a temperature of at least about 700° C. Since the first and second components were preheated before the exothermic reaction is initiated in the second material and are thus already at an elevated temperature, less thermal energy given off by the second material is used to heat the first and second components, thus preserving a larger amount of the thermal energy to heat the first material, such that the first material can be brought up to its melting point using the thermal energy given off by the second material. It is noted that, in a preferred embodiment, the step of initiating the exothermic reaction in the second material and melting the first material takes no longer than about 30 seconds.

Once the first material has melted it attaches to the first and second surfaces of the respective first and second components. Thereafter, the first material is cooled and solidified at 216. The cooling process may comprise, for example, exposing the first and second components, with the reactive bonding material therebetween, to “room temperature”, e.g., about 20° C. Once cooled below the melting point, the reactive bonding material solidifies thus forming a structural joint between the first component and the second component and also provides an electrically conductive bond between the first component and the second component. It is noted that other methods may be performed to cool the reactive bonding material and that the term “room temperature” may encompass a substantial temperature range, as will be apparent to those skilled in the art.

At 218, the joined first and second components are cleaned, such as with a solvent, e.g., a denatured alcohol.

The present invention provides a method for joining conductors formed at least partially from copper or a copper alloy using a reactive bonding material that includes a brazing material and an exothermically reactive material. The use of the exothermically reactive material allows for localized thermal energy to be applied to melt the brazing material, such that access to joints between components to be joined is more easily achieved than in prior art brazing procedures that use external heat sources to melt the brazing material. That is, the thermal energy given off by the exothermically reactive material may be narrowly focused directly on the brazing material and the first and second surfaces of the components to be joined. This is believed to result in a strengthening of the structural bond between the joined components and a decrease in the amount of electrical resistance of the reactive bonding material, as opposed to prior art brazed joints. Moreover, use of the reactive bonding material to join the components allows for a precise placement of the braze joints, which is believed to increase the quality of the braze joint.

Further, the thermal energy from the exothermically reactive material is provided immediately adjacent to the brazing material and the first and second surfaces of the components to be joined. Thus, reduced volumes of the components are exposed to the thermal energy required to melt the brazing material, e.g., about 700° C., as opposed to prior art brazing procedures that employ external heat sources to melt the brazing material, wherein large volumes of the components to be joined proximate to the braze location are heated up to temperatures required to melt the brazing material. The thermal energy being provided by the exothermically reactive material according to the present invention is advantageous, since heating large volumes of the components to be joined up to temperatures required to melt the brazing material can cause undesired alterations of mechanical and/or electrical properties of the components.

Still further, the preheating of the first and second components before the initiation of the exothermic reaction in the exothermically reactive material provides additional benefits. For example, through the implementation of preheating the components to be joined, additional thermal energy is reserved for melting of the brazing material. Without the addition of the additional thermal energy provided by preheating, the structure composed of highly conductive copper material, e.g., the first and second components, will absorb sufficient thermal energy from the exothermically reactive material such that melting of the brazing material may not occur.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method for joining components to be used in an electrical generator comprising:
providing a first component having a first surface;
providing a second component having a second surface;
disposing a reactive bonding material between and in contact with the first surface and the second surface, the reactive bonding material including a first material comprising a brazing material and a second material capable of melting the first material upon an initiation of an exothermic reaction in the second material;
employing a first heating process to preheat at least one of the first surface and the second surface to a temperature lower than a melting temperature of the first material of the reactive bonding material;
after the first heating process, initiating an exothermic reaction in the second material to effect a second heating process different from the first heating process, the second heating process effecting a release of thermal energy from the second material to the first material to melt the first material; and
wherein, upon a cooling and solidification of the first material, the first material creates a bond between the first surface and the second surface to join the first component to the second component.

2. The method according to claim 1, wherein disposing a reactive bonding material between the first surface and the second surface comprises disposing a reactive bonding material comprising plural alternating layers of the first material and the second material between the first surface and the second surface.

3. (canceled)

4. The method according to claim 1, wherein disposing a reactive bonding material between the first surface and the second surface comprises disposing a reactive bonding material including a first material comprising a brazing material and a second material capable of melting the first material upon an initiation of an exothermic reaction in the second material between the first surface and the second surface, wherein the first material comprises silver, copper, and at least one of phosphorus, cadmium, nickel, tin and zinc.

5. The method according to claim 1, wherein disposing a reactive bonding material between the first surface and the second surface comprises disposing a reactive bonding material including a first material comprising a brazing material and a second material capable of melting the first material upon an initiation of an exothermic reaction in the second material between the first surface and the second surface, wherein the second material comprises an exothermic powder layer.

6. The method according to claim 1, wherein initiating an exothermic reaction in the second material comprises applying an electrical impulse to the second material to initiate the exothermic reaction in the second material.

7. The method according to claim 1, further comprising, before the first material cools and solidifies, applying pressure to at least one of the first component and the second component in a direction toward the reactive bonding material.

8. The method according to claim 1, wherein providing the first component comprises providing a first generator winding and wherein providing the second component comprises providing a second generator winding.

9. The method according to claim 1, wherein providing the first component comprises providing a first component formed at least partially from copper and wherein providing the second component comprises providing a second component formed at least partially from copper.

10. The method according to claim 1, further comprising cleaning the first surface of the first component and cleaning the second surface of the second component.

11. The method according to claim 10, wherein disposing a reactive bonding material between the first surface and the second surface further comprises disposing a third material between the first surface and the second surface, the third material comprising a fluxing agent that cleans the first surface and the second surface.

12. The method according to claim 1, wherein upon the initiation of the exothermic reaction, the second material provides thermal energy to the first material to heat the first material up to a temperature of at least about 700° Celsius (C) to melt the first material.

13. The method according to claim 1, wherein the step of initiating an exothermic reaction in the second material to melt the first material takes no longer than about 30 seconds.

14. The method according to claim 1, wherein, upon the cooling and solidification of the first material, the reactive bonding material provides an electrically conductive bond between the first component and the second component.

15. The method according to claim 1, wherein employing a first heating process to preheat at least one of the first surface and the second surface comprises heating at least one of the first surface and the second surface up to a temperature in a range from about 100° C. to about 400° C.

16. A method for joining and forming an electrical connection between electrically conductive components to be used in an electrical generator comprising:
providing a first electrically conductive component having a first surface;
providing a second electrically conductive component having a second surface;
disposing a reactive bonding material between and in contact with the first surface and the second surface, the reactive bonding material including a first material comprising a brazing material and a second material capable of melting the first material upon an initiation of an exothermic reaction in the second material;
employing a first heating process to preheat the first surface and the second surface to a preheat temperature of at least about 100° C. and less than a melting temperature of the first material of the reactive bonding material;
after the first surface and the second surface have been preheated to the preheat temperature, initiating an exothermic reaction in the second material to effect a second heating process different from the first heating process, the second heating process effecting a release of thermal energy from the second material to the first material to melt the first material; and
wherein, upon a cooling and solidification of the first material, the first material creates an electrically conductive bond between the first surface and the second surface to join the first component to the second component.

17. (canceled)

18. The method according to claim 16, wherein providing the first component comprises providing a first generator winding comprising copper and wherein providing the second component comprises providing a second generator winding comprising copper.

19. (canceled)

20. (canceled)

21. The method according to claim 16, wherein initiating an exothermic reaction in the second material comprises applying an electrical impulse to the second material to initiate the exothermic reaction in the second material.

22. The method according to claim 16, wherein disposing a reactive bonding material between the first surface and the second surface further comprises disposing a third material between the first surface and the second surface, the third material comprising a fluxing agent that cleans the first surface and the second surface.

23. The method according to claim 16, wherein, upon the initiation of the exothermic reaction, the second material provides thermal energy to the first material to heat the first material up to a temperature of at least about 700° Celsius (C) to melt the first material.

24. The method according to claim 16, wherein the step of initiating an exothermic reaction in the second material to melt the first material takes no longer than about 30 seconds.
